(19) United States
(12) Patent Application Publication
(10) Pub. No.: US 2014/0349026 A1
(43) Pub. Date: Nov. 27, 2014

(54) FILM FORMING METHOD

(71) Applicant: NIPPON STEEL & SUMITOMO METAL CORPORATION, Tokyo (JP)

(72) Inventor: Jun Masabuchi, Tokyo (JP)

(21) Appl. No.: 14/371,518

(22) PCT Filed: Dec. 4, 2012
(86) PCT No.: PCT/JP2012/007750

§ 371 Date: Jul. 10, 2014

(30) Foreign Application Priority Data
Jan. 12, 2012 (JP) 2012-004172

(51) Int. Cl. B05D 3/06; B05D 3/00; B05D 7/14

(52) U.S. Cl. CPC B05D 3/067; B05D 7/14; B05D 3/002
USPC 427/508

(57) ABSTRACT

A film forming method includes coating a surface of a steel material with an ultraviolet cured paint controlled to a predetermined control temperature and then radiating the coated paint with ultraviolet rays to cure the coated paint and form the film. When the steel material surface is coated with the ultraviolet cured paint, the steel material surface temperature is controlled within a range of −5° C. to +20° C. with reference to the control temperature, whereby a film having an even thickness distribution can be formed on the surface of the steel material. In order to make the thickness distribution of the film formed on the surface of the steel material evener and prevent a visually-observable irregular pattern from occurring and improve the appearance of the film, it is preferable to control the surface temperature of the steel material within a range of 0° C. to +10° C. with reference to the control temperature.

### TECHNICAL FIELD

The present invention relates to a method for forming a film, the method including the steps of: coating a steel surface with an ultraviolet cured paint; and then exposing the coated paint with UV radiation to cure the coated paint to thereby form a film. More specifically, the present invention relates to a film forming method that enables a film with an even thickness distribution to be formed on a steel surface.

### BACKGROUND ART

In some cases, for the purpose of preventing corrosion, a film is formed on the entire surface or a machined surface of steel materials such as a steel pipe and a steel bar. In this case where the film is formed on the surface of the steel material, an ultraviolet cured paint (UV paint) is used in some cases because the ultraviolet cured paint is excellent in corrosion prevention and fast-drying characteristic.

A film with an ultraviolet cured paint can be formed, for example, by the following steps:
(1) heating or cooling the ultraviolet cured paint to control the temperature of the ultraviolet cured paint to a predetermined control temperature;
(2) spraying the ultraviolet cured paint to a surface of a steel material to coat the surface of the steel material with the ultraviolet cured paint to thereby form a paint layer on the surface of the steel material; and
(3) radiating a coated paint (paint layer) with ultraviolet rays by means of an ultraviolet radiation apparatus to cure the coated paint (paint layer) to thereby form a film.

Here, the ultraviolet cured paint has a temperature-dependent viscosity-characteristic. When the temperature of the ultraviolet cured paint is lower than the predetermined control temperature, the viscosity of the ultraviolet cured paint increases. When the viscosity of the ultraviolet cured paint is too high, the ultraviolet cured paint clogs the piping of a coating apparatus in some cases. Further, the thickness distribution of the film formed on the surface of the steel material becomes uneven in some cases. In particular, when the surface of a steel pipe or a steel bar is coated with the ultraviolet cured paint, the surface to be coated is a curved surface and hence it is difficult to evenly coat the surface with the paint, so that the film is prone to have an uneven thickness distribution. On the other hand, when the temperature of the ultraviolet cured paint is higher than the predetermined control temperature, the viscosity of the ultraviolet cured paint is a little lowered, though without any significant change, but the quality of the ultraviolet cured paint may be affected by heat.

For this reason, as shown in (1) of the steps described above, the ultraviolet cured paint is heated or cooled, thereby being controlled to the predetermined control temperature. As for the ultraviolet cured paint, generally, optimum conditions in applying the ultraviolet cured paint are specified in terms of viscosity and temperature for each ultraviolet cured paint by a paint producer. Hence, the control temperature can be set on the basis of the optimum conditions.

However, when the film is formed on the surface of a steel material according to the steps described above, even if the temperature of the ultraviolet cured paint is adjusted to the control temperature, that is, even if the optimum conditions specified by the paint producer are satisfied, in some cases, unevenness is developed in the film such that a portion having a film not formed thereon (portion in which the surface of the steel material is exposed) is generated. Further, in some cases, the film locally fluctuates in thickness and hence a portion whose thickness is thin or thick may be sporadically developed in the formed film.

FIGS. 1(a) and 1(b) are schematic illustrations to show thickness fluctuations of a film formed on a surface of a steel material. FIG. 1(a) shows a case in which an exposed portion without a film is formed on the surface of the steel material and FIG. 1(b) shows a case in which the thickness of the film locally fluctuates. In FIG. 1(a) and FIG. 1(b) are shown a steel material 11 having a film formed thereon and a film 12 formed on the surface of the steel material 11. As shown in FIG. 1(a), when unevenness is developed in the film 12, leaving a part of the steel material devoid of the film 12 and the surface exposed, the effect of preventing corrosion by the formation of the film is hardly produced.

Further, as shown in FIG. 1(b), even when the film is formed and hence the surface of the steel material is not exposed, if the thickness of the film 12 fluctuates, a portion having a thin thickness film formed thereon is prone to decrease in the effect of preventing corrosion. The thickness fluctuations of the film formed on the surface of the steel material can be evaluated by measuring a thickness distribution and by determining whether or not the thickness distribution of the film is within an allowable range against a target value, as shown in FIG. 1(b). The target value and the allowable range can be set at 30±5 μm.

When such a portion devoid of the film is developed and the thickness distribution of the film is unevenly generated, deviating from the allowable range, since it is difficult to remove the once formed film from the surface of the steel material, hence the resulting product becomes defective.

Even when the thickness distribution of the film formed on the surface of the steel material satisfies the allowable range of ±5 μm, an irregular pattern may sometimes be noticed when the film is visually observed. When the irregular pattern is observed, an aesthetic appearance may be impaired and hence the commercial value may be deteriorated. Thus, it is desired to form a film having a thickness distribution that is even as much as possible.

Various proposals have been made for a method for forming a film on a surface of a steel material by an ultraviolet cured paint, for example, there are proposed patent literatures 1, 2. According to a film fainting method described in patent literature 1, when a tubular or bar shaped material such as a steel pipe having its surface coated with an ultraviolet cured paint moves in a bushing through which ultraviolet rays can permeate, the coated ultraviolet cured paint is radiated with the ultraviolet rays through the bushing and a space between the bushing and the tubular or bar shaped material is filled with an inert gas. In this film forming method described in patent literature 1, it teaches that oxygen contained in air and a surface layer portion of the coated ultraviolet cured paint bring about a chemical reaction to make it possible to facilitate ultraviolet rays to reach a deep portion of the coated layer, which is, otherwise, an unreachable portion. As a result, it teaches that the coated ultraviolet cured paint can be efficiently cured.

Further, according to a film forming method described in patent literature 2, the ultraviolet cured paint is applied to the outer surface of a metal pipe and the coated ultraviolet cured paint is radiated with ultraviolet rays, thereby being cured, and then the outer surface side of the metal pipe is heated, and then the outer surface is coated with a water-based paint. In the film forming method described in patent literature 2, it teaches that by applying the ultraviolet cured paint to form a film, the effect of preventing corrosion can be ensured and the overcoatablity of the outer surface of the metal pipe can be improved. In addition, an overcoated film is formed by heating and with a water-based paint, whereby color coding for identification can be made.

In these film forming methods in the prior art, the thickness fluctuations of the film formed on the surface of the steel material are not studied.

### CITATION LIST

### Patent Literature

Patent Literature 1: Japanese Patent Application Publication No. 58-101765
Patent Literature 2: Japanese Patent Application Publication No. 7-8898

### SUMMARY OF INVENTION

### Technical Problem

As described above, when a film is formed on a surface of a steel material by an ultraviolet cured paint, the film may sometimes accompany thickness fluctuations and or irregularity even if the temperature of the paint is controlled to a predetermined control temperature, thereby causing the surface of the steel material to be partially exposed or to develop thickness fluctuations of the film. On the other hand, in the film forming method in the prior art, the thickness fluctuations of the film formed on the surface of the steel material are not studied.

The present invention has been made in view of this situation, and an object of the present invention is to provide a film forming method that enables a film having an even thickness distribution to be formed on an entire surface or a machined surface (for example, work surface subjected to a threading processing or a grinding processing) of a steel pipe or a steel bar.

### Solution to Problem

The present inventor conducted various tests and rigorous studies in order to solve the problems described above and acquired the following findings.
(1) When a surface of a steel material is coated with an ultraviolet cured paint, a surface temperature of the steel material is controlled within a predetermined range based on a known control temperature of the ultraviolet cured paint.
(2) According to (1) described above, a film formed on the surface of the steel material can be made to have an even thickness distribution.

The present invention was completed on the basis of the findings described above and test results shown by examples, which will be described later, and the summary of the present invention consists in a film forming method to be described below.

A method for forming a film, including the steps of: coating a surface of a steel material with an ultraviolet cured paint that is controlled to a predetermined control temperature; and then radiating the coated paint with ultraviolet rays to cure the coated paint to thereby form a film, characterized in that when the surface of the steel material is coated with the ultraviolet cured paint, a surface temperature of the steel material is controlled within a range of −5° C. to +20° C. with reference to the predetermined control temperature.

In the film forming method according to the present invention, “a range of −5° C. to +20° C. with reference to a predetermined control temperature” means a range in which the lower limit is a temperature obtained by subtracting 5° C. from the control temperature and in which the upper limit is a temperature obtained by adding 20° C. to the control temperature. For example, in the case where the predetermined control temperature is set at 30° C., the range means a range of 25° C. to 50° C.

### Advantageous Effects of Invention

The film forming method according to the present invention produces the following distinguished effects.
(1) When a surface of a steel material is coated with an ultraviolet cured paint, by controlling the temperature of the surface of the steel material to within a range of −5° C. to +20° C. with reference to a predetermined control temperature, a film having an even thickness distribution can be formed.
(2) When the temperature of the surface of the steel material is controlled to within a range of 0° C. to +10° C. with reference to the predetermined control temperature, the thickness distribution of the film can be even as much as possible and a beautiful appearance can be achieved for the film.

### BRIEF DESCRIPTION OF DRAWINGS

FIGS. 1(a) and 1(b) are schematic illustrations to show thickness fluctuations of a film formed on a surface of a steel material. FIG. 1(a) shows a case where an exposed portion is generated on the surface of the steel material and FIG. 1(b) shows a case where the thickness of the film locally fluctuates.

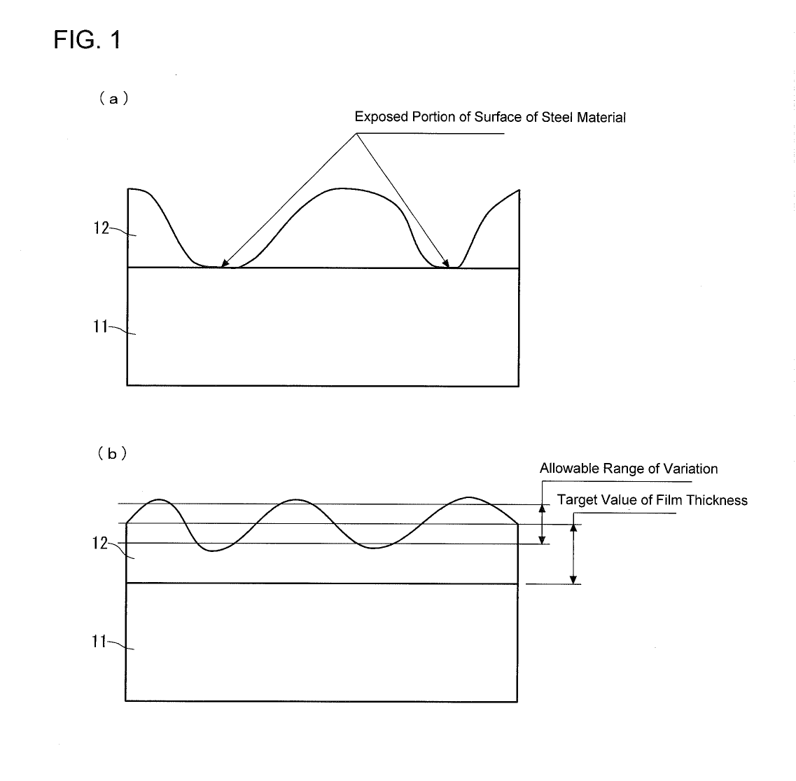

FIGS. 2(a), 2(b), and 2(c) are photographs each showing an appearance of a film formed on the outer surface of a steel pipe in EXAMPLES. FIGS. 2(a), 2(b), and 2(c) show Inventive Example 1 of the invention, Inventive Example 2 thereof, and Comparative Example, respectively.

### DESCRIPTION OF EMBODIMENTS

As described above, a film forming method according to the present invention is a method including steps of: coating a surface of a steel material with an ultraviolet cured paint having temperature controlled to a predetermined control temperature; and then radiating the coated paint with ultraviolet rays to cure the coated paint to thereby form a film. The method is characterized in that when the surface of the steel material such as an entire surface or a machined surface of a steel pipe is coated with the ultraviolet cured paint, the surface of the steel material is coated with the ultraviolet cured paint wherein a surface temperature of the steel material is controlled to within a range of −5° C. to +20° C. with reference to a predetermined control temperature. Described in the following are reasons why the film forming method according to the present invention is specified as described above and a preferable range is set forth.

In the film forming method according to the present invention, the temperature of the ultraviolet cured paint applied to the surface of the steel material is adjusted to a predetermined control temperature. As for the control temperature, as described above, an optimum condition when the ultraviolet cured paint is applied is specified in terms of viscosity and/or temperature for each ultraviolet cured paint by a paint producer, so that a predetermined control temperature can be set on the basis of the optimum condition. For example, when the ultraviolet cured paint to be applied has an optimum condition specified in terms of viscosity, it is recommended that by measuring viscosity while varying temperatures of the ultraviolet cured paint, the temperature for the specified viscosity is located and thus obtained temperature is set to a predetermined control temperature.

When the surface of the steel material is coated with the ultraviolet cured paint, in the film forming method in the prior art, a surface temperature of the steel material is not controlled. In this case, when the surface of the steel material is coated with the ultraviolet cured paint by spraying the ultraviolet cured paint from a nozzle, the ultraviolet cured paint in the form of mist easily exchanges heat with an atmosphere, so that the ultraviolet cured paint is deprived of its heat and hence reaches the surface of the steel material in the state where its temperature drops to increase its viscosity. Further, since the temperature of the surface of the steel material is not controlled, the coated ultraviolet cured paint is deprived of heat and hence the temperature of the ultraviolet cured paint further drops to increase its viscosity. In this way, the ultraviolet cured paint in the form of mist reaching the surface of the steel material increases in viscosity and hence is hard to stretch and spread on the surface (impairs wettability), which hence causes an uneven distribution or fluctuations of thickness of a film formed of the ultraviolet cured paint.

In contrast to this, in the film forming method according to the present invention, the ultraviolet cured paint is applied with the temperature of the surface of the steel material being controlled to within a range of −5° C. to +20° C. with reference to a control temperature. In this way, even when the ultraviolet cured paint reaching the surface of the steel material in the form of mist is deprived of heat and hence increases in viscosity when it is sprayed, the ultraviolet cured paint is supplied with heat from the steel material to thereby have a suitable viscosity. In this way, the ultraviolet cured paint reaching the surface of the steel material in the form of mist has the suitable viscosity, so that the ultraviolet cured paint easily stretches and spreads on the surface of the steel material (improves wettability), which hence can form a film having an even thickness distribution.

When the temperature of the surface of the steel material is lower than the lower limit of the range of −5° C. to +20° C. with reference to the control temperature, in some cases, a thickness distribution of the film formed on the surface of the steel material deviates beyond a range of a target value ±5 μm. On the other hand, when the temperature of the surface of the steel material is higher than the upper limit of the range of −5° C. to +20° C. with reference to the control temperature, the ultraviolet cured paint is liable to become too high in temperature and to have its quality affected.

In the film forming method according to the present invention, it is preferable that the temperature of the surface of the steel material is controlled to within a range of 0° C. to +10° C. with reference to a control temperature. In this way, the film formed on the surface of the steel material has its thickness distribution controlled within a range of a target value ±5 μm and, in addition, an irregular pattern caused by thickness fluctuations of the film is not observed and hence a fine appearance is obtained in the film

In the film forming method according to the present invention, there are no limitations on the ultraviolet cured paint, but in order to prevent the ultraviolet cured paint from clogging the piping of a coating apparatus to cause a trouble in handling when the ultraviolet cured paint is applied, it is preferable that an ultraviolet cured paint having a viscosity of 40 to 90 seconds in terms of Ford Cup No. 4 at a control temperature is used as the ultraviolet cured paint.

There is no limitation on a method for controlling the temperature of the surface of the steel material to within a predetermined range based on the control temperature and the temperature of the surface of the steel material can be controlled by a heating or cooling method used in the prior art. For example, the temperature of the surface of the steel material can be controlled by blowing hot air or cold air onto the surface of the steel material on which a film is to be formed.

In the film forming method according to the present invention, a spray coating or a brush coating can be employed as a method for coating the surface of the steel with the ultraviolet cured paint. However, in the viewpoint of forming a film having an even thickness distribution, it is preferable to employ a method of spraying an ultraviolet cured paint from a nozzle.

When the ultraviolet cured paint applied to the surface of the steel material is radiated with ultraviolet rays, it is important to make an integrated value of the ultraviolet rays to be radiated (=intensity of ultraviolet rays×radiation time) even in the surface coated with the ultraviolet cured paint. This is because when the integrated value of the ultraviolet rays varies in the surface coated with the ultraviolet cured paint, fluctuations/irregularity are caused in the state where the ultraviolet cured paint is cured to thereby impair the appearance of the surface of the film. For this reason, the following methods can be employed: for example, a method of radiating a steel material with ultraviolet rays by a stationary ultraviolet radiation apparatus while moving the steel material at a constant speed; and a method of radiating the entire surface of a steel material coated with an ultraviolet cured paint with ultraviolet rays. Further, when the ultraviolet cured paint applied to an outer surface of a steel pipe or a steel bar is radiated with the ultraviolet rays, it is possible to employ a method of radiating a steel pipe or a steel bar with the ultraviolet rays by a stationary ultraviolet radiation apparatus while rotating the workpiece at a constant speed of rotation.

### EXAMPLES

In order to examine an effect produced by the film forming method according to the present invention, tests were conducted. In the tests, a film was formed on a surface of a steel material with an ultraviolet cured paint and a thickness distribution of the film was examined.

### [Test Method]

In the present tests, a steel pipe was used as a steel material and the material grade of the steel pipe was carbon steel and the steel pipe had an outside diameter of 177.8 mm and a pipe wall thickness of 9.19 mm. An ultraviolet cured paint under a controlled temperature was sprayed on the outer surface of this steel pipe by use of a nozzle to thereby coat the surface of this steel pipe with the ultraviolet cured paint, and then the coated ultraviolet cured paint was radiated with ultraviolet rays to cure the ultraviolet cured paint, thereby forming a film.

In the ultraviolet cured paint used for the tests, viscosity in coating specified by a paint producer was 50 seconds in terms of Ford Cup No. 4. When the viscosity of the ultraviolet cured paint having a viscosity of 50 seconds in terms of Ford Cup No. 4 was examined with the temperature of the ultraviolet cured paint being varied, it was found that the viscosity was 50 seconds at about 30° C. For this reason, a control temperature of the ultraviolet cured paint was set at 30° C. in the present tests.

In the present tests, by blowing off hot air of 50° C. or cold air of 5° C., the temperature of the outer surface of the steel pipe was controlled to about 35° C. in Inventive Example 1 of the present invention, about 26° C. in Inventive Example 2 of the present invention, and about 15° C. in Comparative Example, respectively. Further, time of spraying the ultraviolet cured paint was controlled in such a way that the thickness of a film formed on the outer surface of the steel pipe became 30 μm (a target value). The ultraviolet cured paint was cured under an integrated light value of 1860 mJ/cm² by means of an ultraviolet radiation apparatus (Type UE031-326-06-CKH-001, made by Iwasaki Electric Co., Ltd.). This ultraviolet radiation apparatus was provided with a high-pressure mercury lamp and had a lamp output set at 120 W/m and a wavelength of the ultraviolet rays radiated by the apparatus was 200 nm.

### [Evaluation Standard]

The film formed on the outer surface of the steel pipe had its thickness distribution in a circumferential direction measured and evaluated and was visually observed to evaluate the appearance of the film. The thickness distribution in a circumferential direction was measured at 8 points at a pitch of 45° by use of an eddy current film thickness meter.

The meanings of signs in a column of “evaluation of film thickness distribution” in Table 1, which will be described later, are as follows:
◯: shows that all the measured thicknesses of a film were distributed in a range of 30±5 μm and was good.
x: shows that a part of the measured thickness of a film was beyond the range of 30±5 μm.

The meanings of signs in a column of “evaluation of appearance” in Table 1, which will be described later, are as follows:
◯: shows that an irregular pattern was not discerned and appearance was good.
x: shows that an irregular pattern was observed.

The meanings of signs in a column of “overall evaluation” in Table 1, which will be described later, are as follows:
◯: shows that both of the evaluation of thickness distribution of film and the evaluation of appearance were good (◯).
Δ: shows that the evaluation of thickness distribution of film was good (◯) but the evaluation of appearance was “x”.
x: shows that neither the evaluation of thickness distribution of film nor the evaluation of appearance were poor “x”.

In Table 1 will be shown, respectively, test classification in tests, temperature of the surface of the steel material (outer surface of the steel pipe) at the time of applying an ultraviolet cured paint, evaluation of the thickness distribution of a film, evaluation of appearance, and overall evaluation.

TABLE 1

| | Temperature of | Evaluation of | | Overall |
|---|---|---|---|---|
| | surface of steel | film thickness | Evaluation of | eval- |
| Classification | material (° C.) | distribution | appearance | uation |
| Inventive example | 35 | ◯ | ◯ | ◯ |
| 1 of present | | | | |
| invention | | | | |
| Inventive example | 26 | ◯ | X | Δ |
| 2 of present | | | | |
| invention | | | | |
| Comparative | 15 | X | X | X |
| Example | | | | |

### [Test Result]

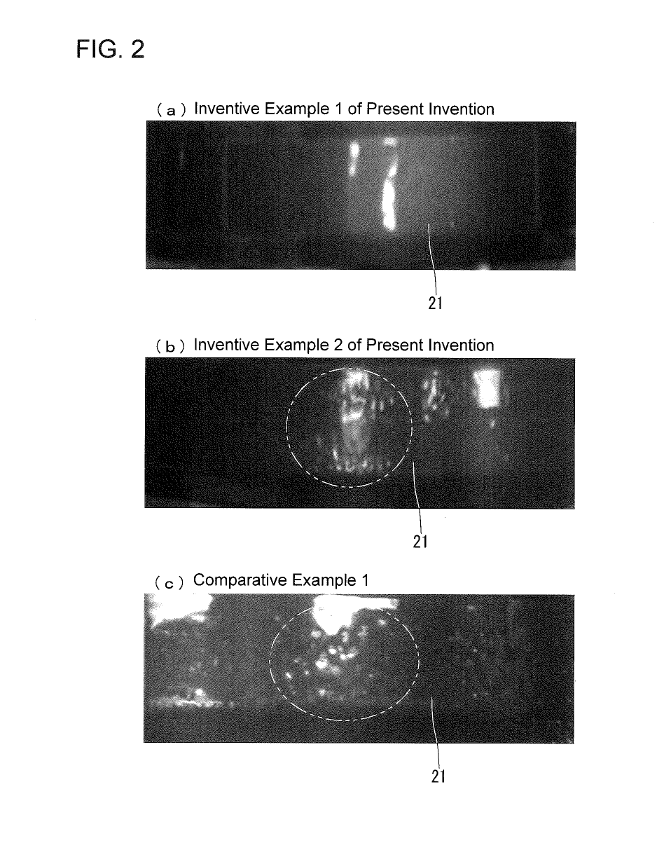

FIGS. 2(a), 2(b), and 2(c) are photographs each showing an appearance of the film formed on the outer surface of the steel pipe in EXAMPLES. FIGS. 2(a), 2(b), and 2(c) show Inventive Example 1 of the present invention, Inventive Example 2 of the present invention, and Comparative Example, respectively. The outer surface 21 of the steel pipe having the film formed thereon of the ultraviolet cured paint will be shown in FIGS. 2(a), 2(b), and 2(c), respectively. In FIGS. 2(a) and 2(b), a part of the observed irregular pattern is encircled and shown by a double dot and dash line.

As is evident from the result shown in Table 1, in the Comparative Example, the temperature of the outer surface of the steel pipe in coating the steel pipe with the ultraviolet cured paint was about 15° C., that is, below the range of −5° C. to +20° C. with reference to the control temperature (30° C.) and hence the thickness distribution of the formed film became uneven and hence the evaluation was x. Further, when the film was observed in appearance, as encircled and shown in FIG. 2(c) by a double dot and dash line, an irregular pattern was observed. For this reason, the overall evaluation of the Comparative Example was x.

In Inventive Example 2 of the present invention, the temperature of the outer surface of the steel pipe in coating it with the ultraviolet cured paint was about 26° C., that is, within the range of −5° C. to +20° C. with reference to the control temperature and hence the thickness distribution of the formed film was good. Further, when the film was observed in appearance, the appearance of the film was improved as compared with the Comparative Example, but as encircled and shown in FIG. 2(b) by a double dot and dash line, an irregular pattern was observed. For this reason, the overall evaluation of Inventive Example 2 of the present invention was Δ.

In Inventive Example 1 of the present invention, the temperature of the outer surface of the steel pipe in coating it with the ultraviolet cured paint was about 35° C., that is, within the range of 0° C. to +10° C. with reference to the control temperature and hence the thickness distribution of the formed film was good. Further, when the film was observed in appearance, as shown in FIG. 2(a), an irregular pattern was not discerned and the appearance of the film was good. For this reason, the overall evaluation of Inventive Example 1 of the present invention was ◯.

In this way, it is evident that when the temperature of the surface of the steel material is controlled to not less than a temperature obtained by subtracting 5° C. from the control temperature, a film having an even thickness distribution can be formed. Further, it is evident that when the temperature of the surface of the steel material is adjusted to the control temperature or more, the thickness distribution of the film can be made evener and the appearance of the film can be made good.

### INDUSTRIAL APPLICABILITY

The film forming method according to the present invention produces the following distinguished effects.
(1) When a surface of a steel material is coated with an ultraviolet cured paint, by controlling the temperature of the surface of the steel material within a range of −5° C. to +20° C. with reference to a predetermined control temperature, a film having an even thickness distribution can be formed.
(2) When the temperature of the surface of the steel material is controlled within a range of 0° C. to +10° C. with reference to the predetermined control temperature, the thickness of the film can be made evener and a fine appearance can be achieved for the film.

When the film forming method according to the present invention is applied to the forming of a film on the surface of the steel material by use of the ultraviolet cured paint, a product defective can be prevented from being caused by fluctuations of thickness of the film formed on the surface of the steel material. Hence, the film forming method according to the present invention can be effectively applied to the forming of a film on the surface of the steel material by use of the ultraviolet cured paint. In particular, the film forming method according to the present invention can be effectively applied in the case where an entire surface or a machined surface (work surface subjected to a threading processing or a grinding processing) of a steel pipe is coated with the ultraviolet cured paint. The film forming method according to the present invention can be applied not only to the entire surface of a steel pipe but also to only a portion that is prone to get rusted, such as a machined surface. According to the film forming method of the present invention, an uniform film can be formed on the entire surface or the machined surface of the steel pipe on which is hard to form an uniform film.

### REFERENCE SIGNS LIST

11: steel material
12: film
21: outer surface of steel pipe having film formed thereon

What is claimed is:

1. A method for forming a film, comprising the steps of: coating a surface of a steel material with an ultraviolet cured paint that is controlled to a predetermined control temperature; and then radiating the coated paint with ultraviolet rays to cure the coated paint to thereby form a film, wherein when the surface of the steel material is coated with the ultraviolet cured paint, a surface temperature of the steel material is controlled within a range of −5° C. to +20° C. with reference to the predetermined control temperature.
